(19) United States
(12) Patent Application Publication
(10) Pub. No.: US 2008/0203256 A1
(43) Pub. Date: Aug. 28, 2008

(54) Retention apparatus for stabilizing a merchandise display assembly on a shelf

(75) Inventor: Michael D. Medcalf, Harrah, OK (US)

Correspondence Address: DUNLAP CODDING & ROGERS, P.C., PO BOX 16370, OKLAHOMA CITY, OK, 73113, US

(73) Assignee: Excell Products, Inc.

(21) Appl. No.: 11/709,611

(22) Filed: Feb. 22, 2007

(51) Int. Cl. F16B 1/00

(52) U.S. Cl. 248/231.81

(57) ABSTRACT

A retention member for restricting movement of a merchandise display assembly relative to a shelf. The shelf is provided with a substantially planar support surface, a curved front portion shaped for receiving flexible inserts, and a rear portion extending angularly from the planar support surface in a downward direction. The retention member includes an engaging portion and an attachment portion. The engaging portion is shaped to engage at least a portion of at least one of the curved front portion or the rear portion of the shelf. The attachment portion is adapted to engage a portion of the merchandise display so as to substantially restrict movement of the merchandise display assembly relative to the shelf in at least one of a horizontal or vertical direction. Another embodiment of the present invention includes a retention apparatus which includes at least one front retention member and at least one rear retention member. The engaging portion of the front retention member is shaped to engage at least a portion of the curved front portion of the shelf. The engaging portion of the rear retention member is shaped to engage at least a portion of the rear portion of the shelf. The front retention member and the rear retention member cooperate to restrict the merchandise assembly relative to the shelf.

### CROSS-REFERENCE TO RELATED APPLICATIONS

Not applicable.

### BACKGROUND OF THE INVENTION

1. Field of Invention

The present invention relates to a retention apparatus for stabilizing a merchandise display assembly on a shelf, and more particularly but not by way of limitation, to a retention apparatus for stabilizing a merchandise display assembly in at least one of a horizontal or vertical direction on a shelf as merchandise is moved in a forward direction in the merchandise display assembly when forwardmost merchandise is removed from the merchandise display assembly.

2. Brief Description of the Prior Art

Merchandise of various types and sizes are commonly stored on shelves in retail and wholesale outlets so customers can see the merchandise and select merchandise for purchase. In some instances, the shelves are inclined downwardly from the rear of the shelf to the front of the shelf so that the merchandise can be gravity fed to the front of the shelf. However, the use of downwardly inclined shelves is often unsatisfactory because the merchandise at times does not slide smoothly down the shelf and the merchandise can fall over thereby jamming the row or column of merchandise so that the merchandise is prevented from feeding properly or causing the merchandise to be discharged onto the floor. Also, customers may have difficulty in viewing merchandise on lower shelves when the shelves are downwardly inclined.

To overcome this problem, various prior art merchandise display assemblies have been proposed for use on store shelves for feeding merchandise to the front of the shelves as merchandise is removed from the shelves. Such prior art merchandise display assemblies have included pusher assemblies to enhance movement of the merchandise to the front of the shelf. Such pusher assemblies include spring-loaded pusher systems as well as bungee cord pusher systems. However, when employing the prior art merchandise display assemblies problems have been encountered in that it is often difficult to stabilize such merchandise display assemblies on a substantially planar support surface of a shelf in the horizontal and/or vertical direction. That is, as merchandise is moved through the prior art merchandise display assemblies problems have occurred in that the merchandise display assemblies are often not maintained in a stable, fixed position on the substantially planar support surface of the shelf.

Thus, a need exists for a retention apparatus which can readily stabilize a merchandise display assembly without modification of the shelf when merchandise is moved through a merchandise bay of the merchandise display assembly. It is to such a retention assembly that the present invention is directed.

### SUMMARY OF THE INVENTION

In one aspect of the present invention, a retention apparatus is provided for restricting the position of a merchandise display assembly on a substantially planar support system of a shelf as merchandise is moved through a merchandise display bay of the merchandise display assembly. The retention apparatus is configured to have a portion disposed within a curved or channel provided along the front portion of the shelf which is shaped to receive flexible inserts, such as UPC codes, pricing information and the like, and a portion to engage a slot provided within a portion of the merchandise display assembly located in close proximity to a front portion of the shelf.

Broadly, the retention apparatus includes a front or first retention member having an engaging portion and an attachment portion. The engaging portion of the front or first retention member is shaped to be disposed within, and thereby engage, at least a portion of the curved portion or channel of the shelf and the attachment portion is adapted to engage a portion of the merchandise display assembly. The attachment portion is provided with a protrusion extending therefrom which is disposable within a slot positioned near the front portion of the merchandise display assembly. That is, the engaging portion of the front or first retention member is preferably snappingly disposed in at least a portion of the curved portion or channel of the shelf such that, upon disposing the protrusion provided on the attachment portion of the front or first retention member into one of the slots provided in the merchandise display assembly, the front or first retention member connects the merchandise display assembly to the shelf and stabilizes the merchandise display assembly on the substantially planar support surface of the shelf.

The retention apparatus may also include a rear or second retention member adapted to secure a rearward edge of the merchandise display assembly to a rearwardly disposed portion of the shelf. The rear or second retention member is provided with a substantially U-shaped engaging portion adapted to receive at least a portion of a downwardly extending rear portion of the shelf and an attachment portion adapted to engage a portion of the merchandise display assembly. The attachment portion of the rear or second retention member is provided with a protrusion extending therefrom which is disposable within a slot provided in a rearwardly disposed portion of the merchandise display assembly. Thus, in a connected position, the front or first retention member and the rear or second retention member cooperate to stabilize the merchandise display assembly relative to the shelf when merchandise is moved through the merchandise bay of the merchandise display assembly.

### BRIEF DESCRIPTION OF THE DRAWINGS

FIG. 1 is a fragmental, partially exploded pictorial representation of a merchandise display assembly secured to a shelf utilizing the retention apparatus of the present invention.

FIG. 2 is a side elevational view of a front retention member of the retention apparatus of the present invention.

FIG. 3 is a perspective view of the front retention member of FIG. 2.

FIG. 4 is a side elevational view of a rear retention member of the retention apparatus of the present invention.

FIG. 5 is a perspective view of the rear retention member of FIG. 4.

FIG. 6 is a fragmental, side elevational view of a merchandise display assembly secured to a shelf via the front and rear retention members of the retention apparatus of the present invention.

### DETAILED DESCRIPTION

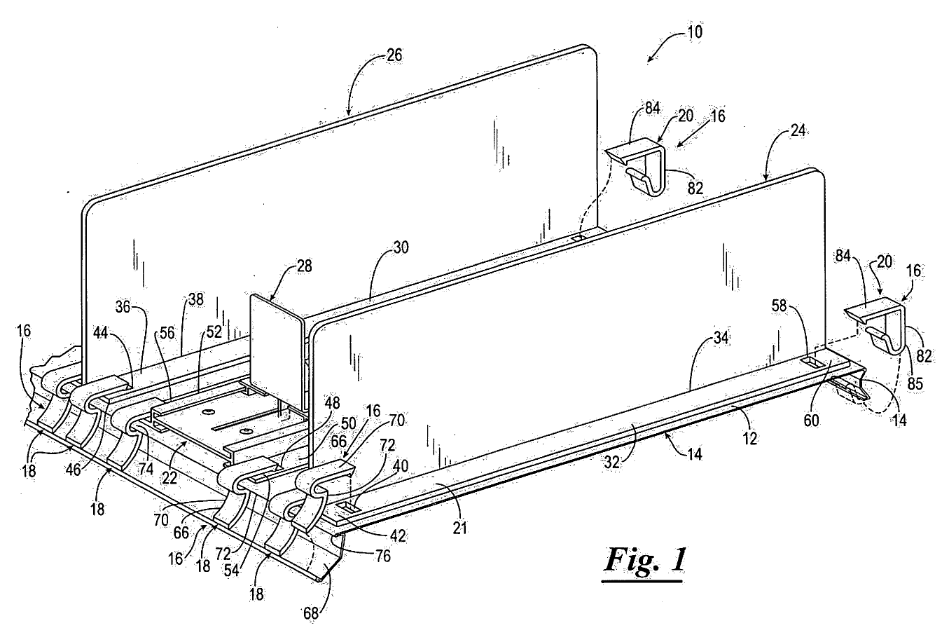

Referring now to the drawings, and more particularly to FIG. 1, shown therein is a merchandise display assembly 10 supported on a substantially planar support surface 12 of a shelf 14 via a retention apparatus 16 of the present invention. As will be more fully described herein after, the retention apparatus 16 desirably includes a plurality of front or first retention members 18 and a plurality of rear or second retention members 20.

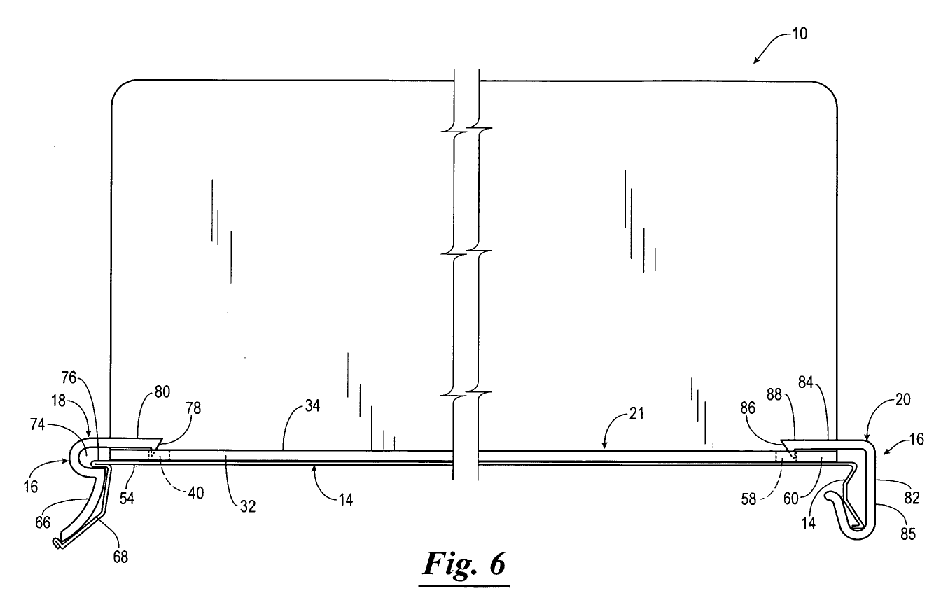

The merchandise display assembly 10 includes a pusher frame 21, a track assembly 22 disposed between spatially disposed sidewalls 24 and 26 and a pusher assembly 28 slidably disposed on the track assembly 22 for feeding a row of merchandise (not shown) in a forward direction through a merchandise bay 30 defined between the sidewalls 24 and 26. The sidewall 24 is provided with a substantially normally disposed foot portion 32 disposed along a lower edge 34 thereof (FIGS. 1 and 6); and the sidewall 26 is also provided with a substantially normally disposed foot portion 36 disposed along a lower end 38 thereof (FIG. 1). At least one slot 40 is provided in the foot portion 32 of the sidewall 24 near a front or forward end 42 thereof; and at least one slot 44 is provided in the foot portion 36 of the sidewall 26 near a front or forward end 46 thereof. In addition, a plurality of slots 48 are preferably provided in track supports 50 and 52 of the track assembly 22 so as to be disposed near a front or forward end 54 or 56, respectively, of the track supports 50 and 52.

At least one slot 58 is provided in the foot portion 32 of the sidewall 24 near a back or rearward end 60 thereof; and at least one slot 62 is provided in the foot portion 36 of the sidewall 26 near a back or rearward end 64 thereof. In addition to the above slots 58 and 62, it should be understood that additional slots (not shown) can be provided along the back or rearward end 60 and 64 of the foot portions 32 and 36 of the sidewall 24 and 26 or in the track supports 50 and 52 of the track assembly 22 so that such slots are disposed near a back or rearward end of the track supports 50 and 52 of the track assembly 22. It should be noted that the distance the slots 40 and 44 are from the front or forward ends 42 and 46 of the foot portions 32 and 36 can vary and will be dependent upon the size of the front or first retention members 16. Similarly, the distance of the slots 58 and 62 are from the back or rearward end 60 and 64 of the foot portions 32 and 36 can vary and will be dependent upon the size and configuration of the rear or second retention members 18. As one will appreciate, the same requirements will be for the position of the additional slots 48 present in the front ends 54 and 56 of the track supports 50 and 52 of the track assembly 22; and the same requirements will be for any additional slots (not shown) disposed near a back or rearward end of the track supports 50 and 52 of the track assembly 22.

The construction and operation of the merchandise display assembly 10, except for the incorporation of the various slots therein, is similar to prior art merchandise display assemblies such as those disclosed in U.S. Ser. No. 11/583,450, entitled “Merchandise Display Rack, filed Oct. 19, 2006, and U.S. Ser. No. 11/639,809, entitled “Pusher Assembly”, filed Dec. 15, 2006, and the entire contents of each being hereby expressly incorporated herein by reference. However, it should be understood that the retention apparatus 16 of the present invention is not limited to the merchandise display assemblies disclosed in the before-referenced pending patent applications, but is applicable for use with any merchandise display assembly provided that the merchandise display assembly is provided with, or can be modified to contain, the required slots for attachment of the retention apparatus 16.

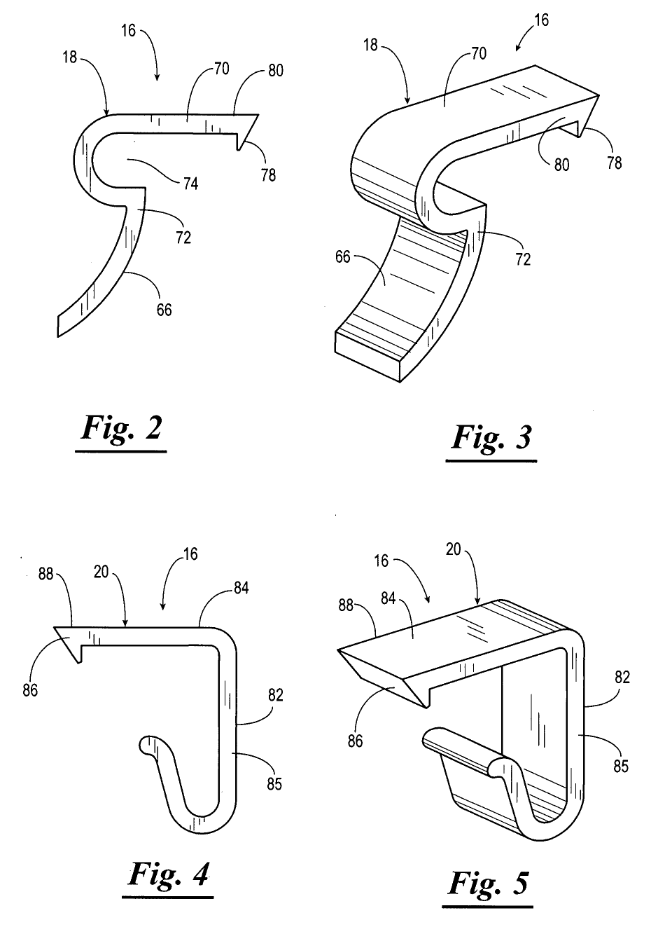

Referring more specifically to FIGS. 1-3 and 6, the front or first retention member 18 of the retention apparatus 16 will be described in more detail. The front or first retention member 18 includes a first leg or portion 66 disposable within a curved portion or channel 68 of the shelf 14 (FIGS. 1 and 6), the curved portion 68 of the shelf 14 being configured to receive flexible inserts, such as UPC codes, pricing information and the like. The first leg or portion 66 of the front or first retention member 18 is desirably fabricated of a flexible material so that the first leg or portion 66 of the front or first retention member 18 can be snappingly disposed within the curved portion or channel 68 of the shelf 14.

The front or first retention member 18 is further provided with a second leg or portion 70 extending from an upper end 72 of the first leg or portion 66 of the front or first retention member 18. The second leg or portion 70 of the front or first retention member 18 is angularly disposed relative to the first leg or portion 66 of the front or first retention member 18.

The second leg or portion 70 of the front or first retention member 18 is provided with a substantially horizontally disposed J-shaped configuration such that an outwardly extending chamber 74 is formed at the junction of the first leg or portion 66 and the second leg or portion 70 of the front or first retention member 18. Thus, when the first leg or portion 66 of the front or first retention member 18 is disposed within the curved portion or channel 68 of the shelf 14, a forwardly extending edge portion 76 of the shelf 14 is disposable within the outwardly extending chamber 74 substantially as shown in FIGS. 1 and 6.

To secure the front or first retention member 18 to the merchandise display assembly 10 for stabilizing the merchandise display assembly 10 on the planar support surface 12 of the shelf 14, the second leg or portion 70 of the front or first retention member 18 is provided with a protrusion or connecting member 78 extending from a distal end 80 thereof, the protrusion or connecting member 78 functioning as an attachment or connector portion for connecting the front or first retention member 18 to the merchandise display assembly 10. That is, when the first leg or portion 66 of the front or first retention member 18 is disposed within the curved front portion 68 of the shelf 14 and aligned with one of the slots, such as the slot 40, provided in the front or forward end 42 of the foot portion 32, and the protrusion 78 is disposed within the slot 40, the front or first retention member 18 functions to stabilize the merchandise display assembly 10 on the planar support surface 12 of the shelf 14. By utilizing a second front or first retention member 18 such that the first leg or portion 66 of the front or first retention member 18 is aligned with the slot 44 formed in the front or forward end 46 of the foot portion 36 and the protrusion or connecting member 78 is disposed within the slot 44 in the foot portion 36 of the sidewall 26, the front or first retention members 18 cooperate to secure a forward end portion of the merchandise display assembly 10 in a stable position on the planar support surface 12 of the shelf 14.

The configuration of the first leg or portion 66 of the front or first retention member 18 can vary provided that the first leg or portion 66 of the front or first retention member 18 can be snapingly disposed within the curved portion or channel 68 formed along the front of the shelf 14 which is adapted to receive UPC codes, pricing information and the like. Similarly, the protrusion or connecting member 78 formed on the distal end 80 of the second leg or portion 70 of the front or first retention member 18 is shown as having a substantially triangular configuration. However, it should be understood that the protrusion or connecting member 78 can be of any configuration provided it is adapted to engage either a slot or aperture formed within selected portions of the merchandise display assembly 10 such that upon disposing the first leg or portion 66 of the front or first retention member 18 within the curved portion or channel 68 provided at the front of the shelf 14 and disposing the protrusion or connecting member 78 formed on the distal end 80 of the second leg or portion 70 of the front or first retention member 18 in an appropriate configured slot or aperture, that the front or first retention member 18 cooperates with additional front or first retention members 18 to connect the merchandise display assembly 10 to the shelf 14 and thus stabilize the merchandise display assembly 10 in a substantially stable position so as to substantially restrict movement of the merchandise display assembly 10 relative to the shelf 14 in at least one of a horizontal or vertical direction.

As previously stated, the retention apparatus 16 desirably includes, in addition to at least one and more desirably a plurality of front or first retention members 18, at least one and more desirably a plurality of rear or second retention members 20 which cooperate with the front or first retention members 18 to secure the merchandise display assembly 10 in a stable position on the substantially planar support surface 12 of the shelf 14.

Referring now to FIGS. 1 and 4-6, the rear or second retention member 28 of the retention apparatus 16 will be described in more detail. The rear or second retention member 20 is provided with a first leg or shelf attachment portion 82 and a second leg or portion 84. The first leg or shelf attachment portion 82 is shaped to engage and receive at least a portion of a rear portion of the shelf 14 (FIG. 6); and the second leg or portion 84 is adapted to engage a portion of the merchandise display assembly 10 such that the rear or second retention member 20 cooperates with the front or first retention member 18 to secure the merchandise display assembly 10 in a stable position on the planar support surface 12 of the shelf 14.

The first leg or shelf engaging portion 82 of the rear or second retention member 20 is provided with a substantially J-shaped configuration at a distal end 85 thereof substantially as shown. The substantially J-shaped configuration formed on the distal end 85 of the first leg or shelf engaging portion 82 enables the first leg or shelf engaging portion 82 of the rear or second retention member 20 to receive a downwardly extending rear portion of the shelf 14 such that, upon connecting the second leg or attachment portion 84 of the rear or second retention member 20 to the merchandise display assembly 10, the rear or second retention member 20 is secured to both the shelf 14 and the merchandise display assembly 10 in the manner hereinafter described in more detail.

The second leg or attachment portion 84 of the rear or second retention member 20 is angularly disposed relative to the first leg or shelf engaging portion 82 of the rear or second retention member 20. Generally, the second leg or attachment portion 84 of the rear or second retention member 82 is substantially normally disposed to the first or shelf engaging portion 82 of the rear or second retention member 20. However, the angular disposition of the first leg or shelf engaging portion 82 and the second leg or attachment portion 84 of the rear or second retention member 20 will depend largely upon the angular disposition of a downwardly extending back edge of the shelf 14.

To secure the rear or second retention member 20 to the merchandise display assembly 10 for stabilizing the merchandise display assembly 10 on the planar support surface 12 of the shelf 14, the second leg or attachment portion 84 of the rear or second retention member 20 is provided with a protrusion or connecting member 86 extending from a distal end 88 thereof, the protrusion or connecting member 86 functioning as an attachment portion for connecting the rear or second retention member 20 to the merchandise display assembly 10. That is, when the first leg or shelf engaging portion 82 of the rear or second retention member 20 is disposed about a portion of a downwardly, rearwardly extending edge of the shelf 14 substantially as shown in FIG. 6, and aligned with one of the slots, such as the slot 58 provided in the back or rearward end 60 of the foot portion 32 of the merchandise display assembly 10, and the protrusion connecting member 86 formed on the distal end 88 of the second leg or attachment portion 84 is disposed within the slot 58, the rear or second retention member 20 is connected to the shelf 14 and the merchandise display assembly 10 and functions to stabilize the merchandise display assembly 10 on the planar support surface 12 of the shelf 14. Additional rear or second retention members 20 can be employed along the length of the shelf 14 to enhance stabilization of the merchandise display assembly 10 on the planar support surface 12 of the shelf 14. Further, when employing the rear or second retention member 20 in combination with the front or retention member 18 to stabilize the merchandise display assembly 10 on the planar support surface 12 of the shelf 14, the merchandise display assembly 10 is secured in a substantially stable position on the shelf 14 such that movement of the merchandise display assembly 10 relative to the shelf 14 is restricted in the horizontal and/or vertical direction.

From the above description, it is clear that the retention apparatus 16 of the present invention provides a unique method for stabilizing merchandise display assemblies 10 on the planar support surface 12 of the shelf 14 as merchandise is moved through the merchandise bay 30 of the merchandise display assembly 10. The retention apparatus 16 of the present invention provides a convenient method for horizontal and/or vertical stabilization of the merchandise display assembly 10 on the planar support surface 12 of the shelf 14, and is economical to manufacture and substantially maintenance free.

It should be understood that the specific embodiments of the invention herein illustrated and described are intended to be representative only, and certain changes may be made therein without departing from the teachings of the written description and the accompanying drawings.

Having thus described the invention, what is claimed is:

1. A retention member for restricting the position of a merchandise display assembly relative to a shelf wherein the shelf is provided with a substantially planar support surface, a curved front portion shaped for receiving flexible inserts, and a rear portion extending angularly in a downward direction from the planar support surface, the retention member comprising an engaging portion shaped to engage at least a portion of at least one of the curved front portion or the rear portion of the shelf, the retention member further comprising an attachment portion adapted to engage a portion of the merchandise display so as to substantially restrict the position of the merchandise display assembly relative to the shelf in at least one of a horizontal or vertical direction.

2. The retention member of claim 1 wherein at least a portion of the engaging portion of the retention member is angularly disposed relative to the attachment portion.

3. The retention member of claim 1 wherein the attachment portion of the retention member further comprises a protrusion extending from a distal end thereof wherein the merchandise display assembly has an aperture defined therein for receiving at least a portion of the protrusion.

4. The retention member of claim 1 wherein the engaging portion is snapingly disposed in at least a portion of the curved front portion of the shelf such that the retention member is frictionally connected to the shelf.

5. The retention member of claim 4 wherein the engaging portion is shaped to substantially correspond to the shape of at least a portion of the curved front portion of the shelf.

6. The retention member of claim 1 wherein the engaging portion is adapted to extend about at least a portion of the rear portion of the shelf.

7. A retention apparatus for stabilizing a merchandise display assembly on a shelf wherein the shelf is provided with a substantially planar support surface, a curved front portion shaped to be capable of receiving flexible inserts, and a rear portion extending angularly in a downwardly direction from the planar support surface, the retention apparatus comprising:
a front retention member comprising an engaging portion shaped to frictionally engage at least a portion of the curved front portion of the shelf, the front retention member further comprising an attachment portion adapted to engage a portion of the merchandise display assembly; and
a rear retention member comprising an engaging portion shaped to engage at least a portion of the rear portion of the shelf, the rear retention member further comprising an attachment portion adapted to engage a portion of the merchandise display assembly;
wherein the front retention member and the rear retention member cooperate to stabilize the merchandise display assembly on the shelf in at least one of a horizontal or vertical direction when merchandise is moved in a forward direction in the merchandise display assembly as a forward most merchandise is removed from the merchandise display assembly.

8. The retention apparatus of claim 7 wherein at least a portion of the engaging portion of at least one of the front retention member and the rear retention member is angularly disposed from at least a portion of the respective attachment portion of the at least one of the front retention member and the rear retention member.

9. The retention apparatus of claim 7 wherein at least a portion of the engaging portions of both the front and rear retention members are angularly disposed from at least a portion of the respective attachment portions of both the front and rear retention members.

10. The retention apparatus of claim 7 wherein the front retention member and the rear retention member further comprise a protrusion extending therefrom, and wherein the merchandise display assembly is provided with slots for receiving the protrusions.

11. The retention apparatus of claim 7 wherein the engaging portion of the front retention member is adapted to be disposed in at least a portion of the curved front portion of the shelf.

12. The retention apparatus of claim 11 wherein the engaging portion of te front retention member is shaped to correspond to the shape of at least a portion of the curved front portion of the shelf.

13. The retention apparatus of claim 7 wherein the engaging portion of the rear retention member is adapted to extend about at least a portion of the rear portion of the shelf.

14. The retention apparatus of claim 8 wherein the engaging portion of the front retention member is adapted to be disposed in at least a portion of the curved front portion of the shelf.

15. The retention apparatus of claim 14 wherein the engaging portion of the front retention member is shaped to substantially correspond to the shape of at least a portion of the curved front portion of the shelf.

16. The retention apparatus of claim 8 wherein the engaging portion of the rear retention member is adapted to extend about at least a portion of the rear portion of the shelf.

17. The retention apparatus of claim 11 wherein the engaging portion of the front retention member is adapted to be received in at least a portion of the curved front portion of the shelf.

18. The retention apparatus of claim 17 wherein the engaging portion of the front retention member is shaped to substantially correspond to the shape of at least a portion of the curved front portion of the shelf.

19. The retention apparatus of claim 11 wherein the engaging portion of the rear retention member is adapted to extend about at least a portion of the rear portion of the shelf.

20. A retention apparatus for restricting the position of a merchandise display relative to a shelf having a substantially planar support surface, a curved front portion of the shelf shaped to receive flexible inserts, and a rear portion extending angularly from the planar support surface, the merchandise display having at least one front slot and at least one rear slot, the retention apparatus comprising:
a front retention member having an engaging portion shaped to engage at least a portion of the curved front portion of the shelf, the front retention member further comprising an attachment portion adapted to engage a portion of the merchandise display, the attachment portion having a protrusion extending therefrom adapted to be disposed in the at least one front slot of the merchandise display; and
a rear retention member comprising an engaging portion shaped to engage at least a portion of the rear portion of the shelf, the rear retention member further comprising an attachment portion adapted to engage a portion of the merchandise display the attachment portion having a protrusion extending therefrom adapted to be received in the at least one rear slot of the merchandise display;
wherein the front retention member and the rear retention member cooperate to substantially restrict the position of the merchandise display relative to the shelf in at least one of a horizontal or vertical direction.
